(19) United States
(12) Patent Application Publication
(10) Pub. No.: US 2026/0028194 A1
(43) Pub. Date: Jan. 29, 2026

(54) PALLET STACKER

(71) Applicant: QTEK DESIGN LTD., Toronto (CA)

(72) Inventors: Paul Redman, London (CA); Edward Mills, Thorndale (CA); Jacob van Lanen, London (CA)

(21) Appl. No.: 19/271,008

(22) Filed: Jul. 16, 2025

Related U.S. Application Data
(60) Provisional application No. 63/674,527, filed on Jul. 23, 2024.

(51) Int. Cl. B65G 57/16

(52) U.S. Cl. CPC B65G 57/16; B65G 2201/0267

(57) ABSTRACT

A pallet stacker according to an example embodiment includes a corral defining an interior storage space configured to retain a stack of pallets. At least one lifting mechanism is configured to engage a bottom pallet of the stack of pallets, to lift the stack of pallets to permit insertion of at least one new pallet below the stack of pallets, and to lower the stack of pallets onto the new pallet.

### BACKGROUND

Pallets generally include a deck supported above a floor by a plurality of feet or columns. Runners may connect lower ends of the columns. Pallets may be wood or plastic. Pallets are used to efficiently transport goods or other objects through a supply chain.

Storing empty pallets can occupy valuable floor space. Stacking empty pallets may take time, especially if one wants to make sure that the pallets are stored in a stable stack.

### SUMMARY

A pallet stacker according to an example embodiment includes a corral defining an interior storage space configured to retain a stack of pallets. At least one lifting mechanism is configured to engage a bottom pallet of the stack of pallets, to lift the stack of pallets to permit insertion of at least one new pallet below the stack of pallets, and to lower the stack of pallets onto the new pallet.

In some aspects, the techniques described herein relate to a pallet stacker wherein the at least one lifting mechanism includes a latch pivotable and vertically slidable relative to the corral.

In some aspects, the techniques described herein relate to a pallet stacker wherein the latch engages a cam surface that moves the latch between a deployed position and a retracted position.

In some aspects, the techniques described herein relate to a pallet stacker wherein the cam surface moves the latch inward from the retracted position to the deployed position between a floor and four inches above the floor.

In some aspects, the techniques described herein relate to a pallet stacker further including a foot pivotably secured at an lower end of each latch.

In some aspects, the techniques described herein relate to a pallet stacker wherein the at least one lifting mechanism is configured to engage the bottom pallet on a floor and to lift the stack of pallets more than a height of three stacked pallets, but less than a height of four stacked pallets.

In some aspects, the techniques described herein relate to a pallet stacker wherein the at least one lifting mechanism includes a first lifting mechanism and a second lifting mechanism positioned on opposite sides of the interior storage space.

In some aspects, the techniques described herein relate to a pallet stacker wherein each of the first lifting mechanism and the second lifting mechanism includes a piston and hydraulic cylinder connected to a main bracket vertically slidably connected to a slide and at least one latch movable between a deployed position and retracted position.

In some aspects, the techniques described herein relate to a pallet stacker wherein each of the at least latch engages a cam surface that moves the latch inward from the retracted position to the deployed position.

In some aspects, the techniques described herein relate to a pallet stacker wherein the cam surface moves the latch inward from the retracted position to the deployed position as the latch moves upward.

In some aspects, the techniques described herein relate to a pallet stacker wherein the cam surface moves the latch inward from the retracted position to the deployed position between a floor and four inches from the floor.

In some aspects, the techniques described herein relate to a pallet stacker further including a hydraulic pump fluidly connected to the hydraulic cylinder of the first lifting mechanism and the hydraulic cylinder of the second lifting mechanism.

In some aspects, the techniques described herein relate to a pallet stacker further including a user interface including a raise switch and wherein the at least one lifting mechanism is configured to lift the stack of pallets as long as the user engages the raise switch.

In some aspects, the techniques described herein relate to a pallet stacker further including a presence sensor mounted proximate an entry to the storage corral, wherein the at least one lift mechanism is configured to lower the stack of pallets based upon a lack of an indication of presence by the presence sensor.

In some aspects, the techniques described herein relate to a pallet stacker in combination with a plurality of pallets received in the corral, a bottom pallet of the plurality of pallets engaged by the at least one lifting mechanism.

In some aspects, the techniques described herein relate to a pallet stacker including: a corral having a pair of opposed, parallel side walls and a rear wall defining an interior storage space configured to retain a stack of pallets; at least one latch mounted proximate each side wall and pivotable between a retracted position and a deployed position, wherein each latch is slidable vertically relative to the corral; and a foot pivotably mounted to a lower end of each latch.

In some aspects, the techniques described herein relate to a pallet stacker wherein each latch is slidable vertically to move the associated foot upward from a position less than four inches above a floor on which the corral rests upward.

In some aspects, the techniques described herein relate to a pallet stacker wherein each latch engages a cam surface that moves the latch from the retracted position to the deployed position as the foot moves from the floor to four inches above the floor.

In some aspects, the techniques described herein relate to a method for stacking pallets including: a) lifting a stack of pallets off a floor; b) after step a), inserting at least one new pallet below the stack of pallets; and c) after step b), lowering the stack of pallets onto the at least one new pallet.

In some aspects, the techniques described herein relate to a method further including: d) detecting a presence of a pallet or pallet-handling apparatus proximate the stack of pallets; e) after step d), detecting that the pallet or pallet-handling apparatus is no longer present; and f) performing step c) based upon step e).

### BRIEF DESCRIPTION OF THE DRAWINGS

FIG. 1 is a front perspective view of a pallet stacker according to one embodiment.

FIG. 2 is a front perspective view of the pallet stacker from the opposite side.

FIG. 3 shows one of the lifting mechanisms with the covers removed for illustration.

FIG. 4 is an enlarged view of a portion of FIG. 3, focusing on one of the latches.

FIG. 5 is an exterior view of the lifting mechanism with the cover removed.

FIG. 6 is an interior view of the lifting mechanism with the covers removed.

FIG. 7 is a section view through the lifting mechanism while the latch is in the engaged position.

FIG. 8 shows the actuator housing translucent to show a hydraulic pump and

a T-fitting.

FIG. 9 shows the controller of the pallet stacker of FIG. 1.

FIG. 10 is a perspective view of an upper portion of the pallet stacker loaded with pallets.

FIG. 11 is an enlarged view of a portion of the photoelectric eye of the pallet stacker of FIG. 1.

FIG. 12 is a front upper perspective view of the pallet stacker with a plurality of pallets loaded in the corral.

FIG. 13 shows one of the latches in a disengaged position.

FIG. 14 shows the latch of FIG. 13 in an engaged position.

FIG. 15 shows the pallet stacker of FIG. 14 with the stack of pallets lifted to a suspended position.

FIG. 16 shows the pallet stacker of FIG. 15 with a pair of new pallets inserted below the suspended stack of pallets.

FIG. 17 shows the pallet stacker of FIG. 16 with the stack of pallets lowered onto the two new pallets.

FIG. 18 shows the pallet tracker of FIG. 17 with the latch beginning to lower toward the retracted, disengaged position.

FIG. 19 shows the pallet stacker of FIG. 18 with the latch returned to the retracted, disengaged position.

### DETAILED DESCRIPTION

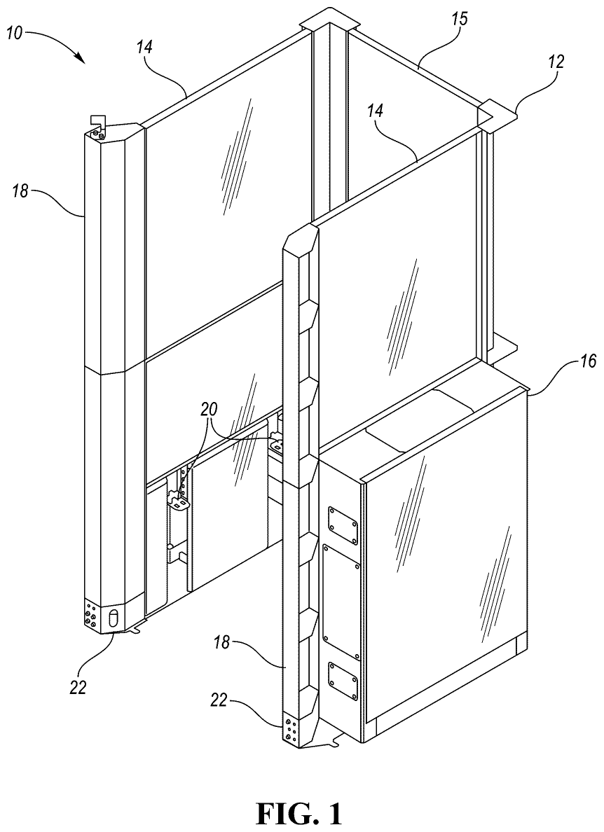

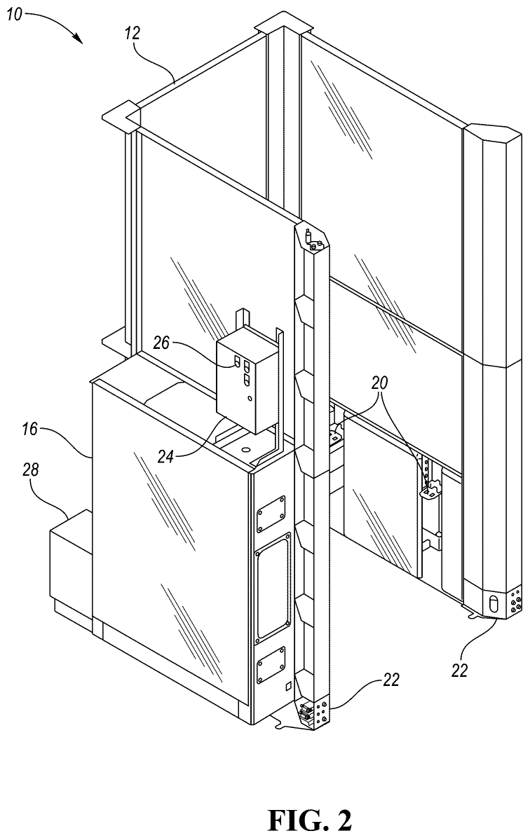

FIG. 1 is a front perspective view of a pallet stacker 10 according to one embodiment. FIG. 2 is a front perspective view of the pallet stacker 10 from the opposite side.

Referring to FIGS. 1 and 2, the pallet stacker 10 includes a corral 12 having two opposed, parallel side walls 14 and a rear wall 15 defining an interior storage space. The corral 12 has an open front leading into the interior storage space.

A lifting mechanism 16 is mounted to an exterior of each of the parallel side walls 14. Front columns 18 are mounted to forward ends of the parallel side walls 14. As will be explained in more detail below, each of the lifting mechanisms 16 includes one or more feet 20 that may project into the interior storage space of the corral 12. A presence sensor, such as a photoelectric eye 22, may be mounted to lower ends of the front columns 18.

Referring to FIG. 2, a controller 24 may include at least one processor and at least one storage storing data and instructions, which when executed by the at least one processor, cause the pallet stacker 10 to perform the functions described herein. The controller 24 receives inputs from the photoelectric eye 22 and from a user interface, such as switches, such as a plurality of buttons 26. The buttons 26 are actuatable by a user and will be described in more detail later below. As shown, an actuator housing 28 may be installed adjacent one of the lifting mechanisms 16.

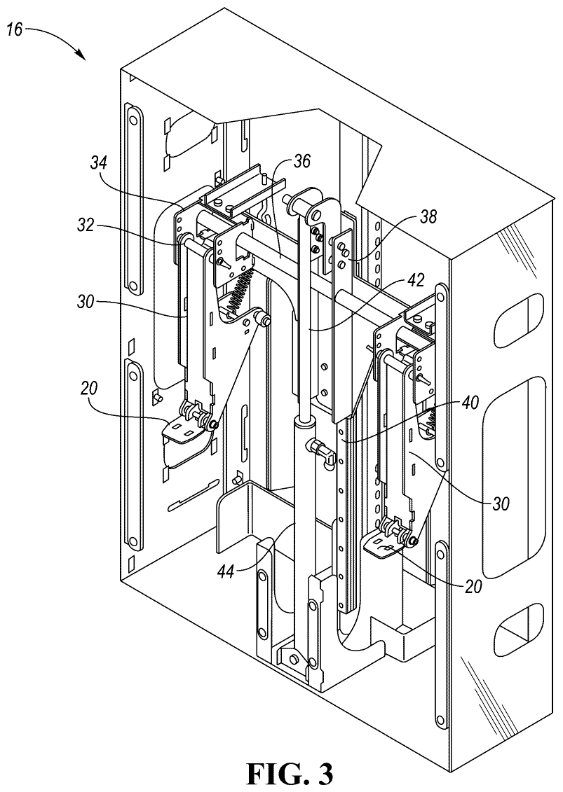

FIG. 3 shows one of the lifting mechanisms 16 with the covers removed for illustration. The other lifting mechanism 16 would be identical. Latches 30 each support one of the feet 20. Each foot 20 is pivotably secured at an outer end thereof to a lower end of one of the latches 30. An upper end of each latch 30 is pivotably secured by a pivot pin 32 to a latch bracket 34. The latch brackets 34 hang on a rod 36, which may be a cold rolled steel tube. The latch brackets 34 may be released and repositioned toward or away from one another along the rod 36 and then resecured, if necessary, to adjust for different pallets.

The rod 36 is supported on a main bracket 38 that is mounted to a slide 40 secured to the lifting mechanism 16 housing. The slide 40 may include a hardened steel rail having a plurality of bearings that permits vertical movement of the slide 40. A piston 42 is slidably received in a hydraulic cylinder 44. An upper end of the piston 42 is coupled to the main bracket 38, such that vertical motion of the piston 42 by the hydraulic cylinder 44 moves the main bracket 38, the rod 36 and the latches 30 vertically. Other actuators, such as electric or pneumatic, could be used instead of the piston 42 and hydraulic cylinder 44.

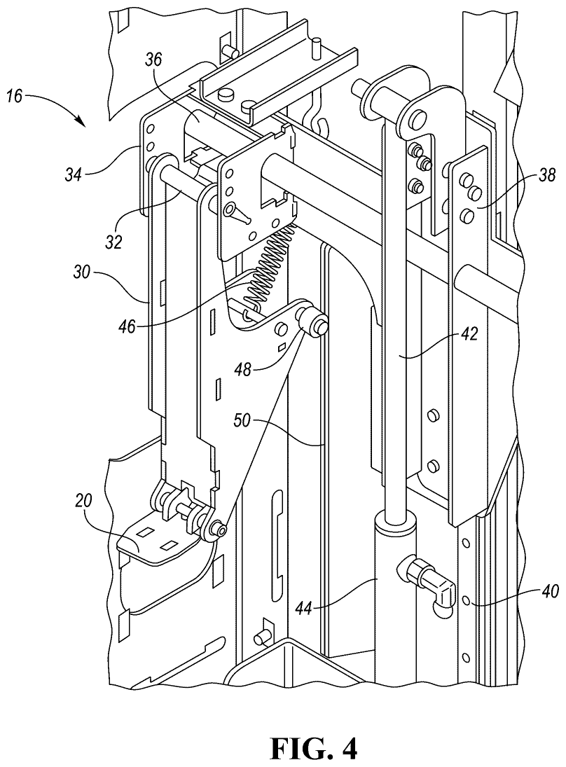

FIG. 4 is an enlarged view of a portion of FIG. 3, focusing on one of the latches 30. As shown, a spring 46 connects an outer portion of the latch 30 to the main bracket 38 (connection not shown) and biases it outward. A wheel 48 is rotatably mounted at an outer portion of the latch 30 and engages a cam 50.

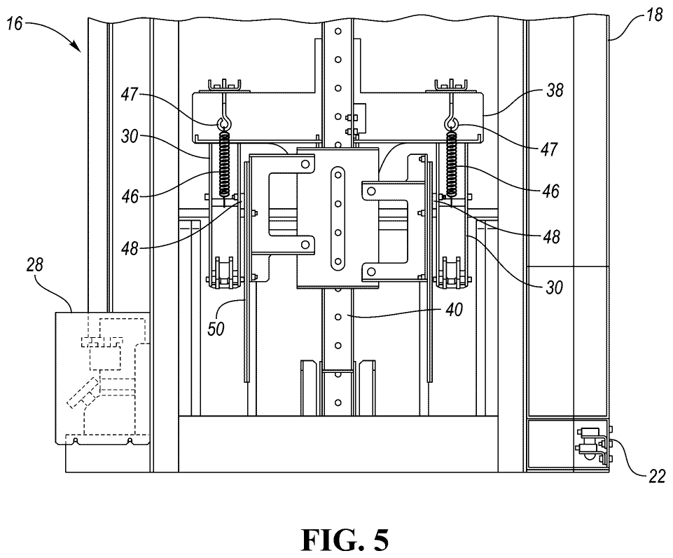

FIG. 5 is an exterior view of the lifting mechanism 16 with the cover removed. The springs 46 are connected to eyelets 47 secured to the main bracket 38.

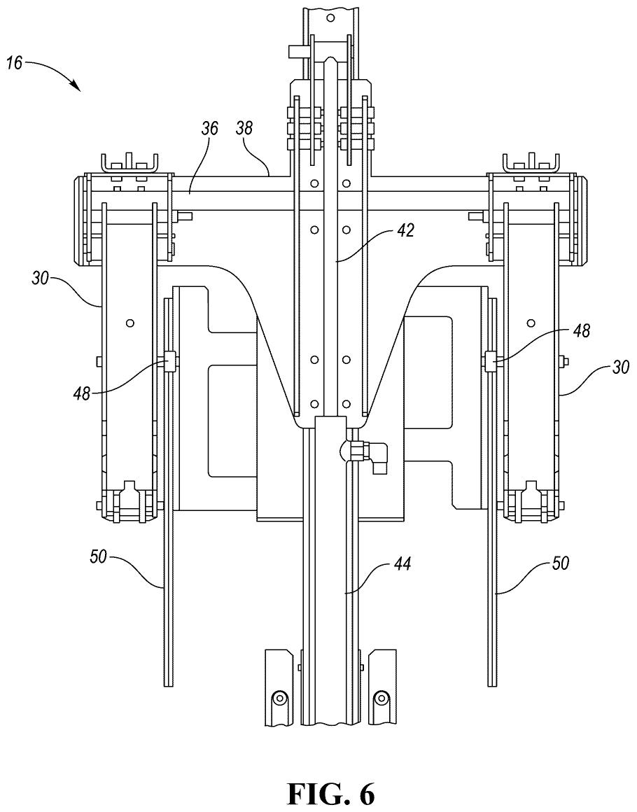

FIG. 6 is an interior view of the lifting mechanism 16 with the covers removed. As shown, the wheels 48 engage the cams 50, which are vertical plates fixed to the housing of the lifting mechanism 16.

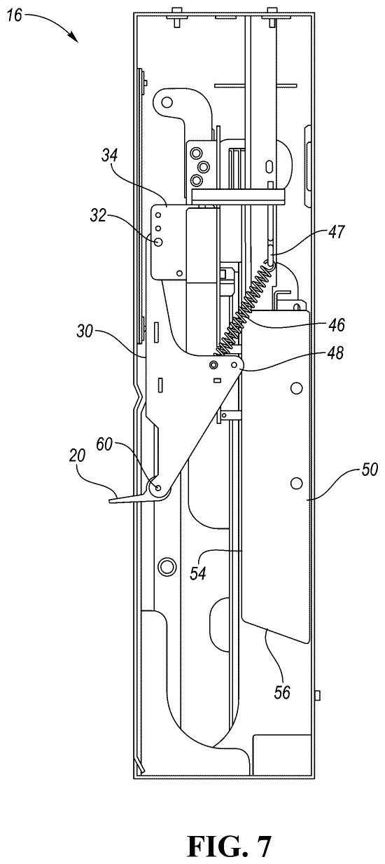

FIG. 7 is a section view through the lifting mechanism 16 while the latch 30 is in the engaged position. The cam 50 has a straight, vertical inner edge 54 leading downward to an outwardly-sloped ramped surface 56. The latch 30 is pivotably connected to the bracket 34 at its upper end via the pivot pin 32. The latch 30 is pivotably connected to the foot 20 at a lower end 60, which in the engaged position (shown) is directly below the upper end and the pivot pin 32.

The spring 46 and the wheel 48 are connected to an outwardly-projecting portion of the latch 30. The outer, upper end of the spring 46 is connected to the eyelet 47, thereby biasing the latch 30 outward (and biasing the latch 30 counterclockwise in FIG. 7). In the engaged position as shown, the wheel 48 engages the vertical inner edge 54 of the cam 50. This holds the latch 30 in the engaged position, such that the foot 20 projects inward into the interior storage space of the corral 12. The foot 20 is rotated downward relative to the latch 30 due to gravity.

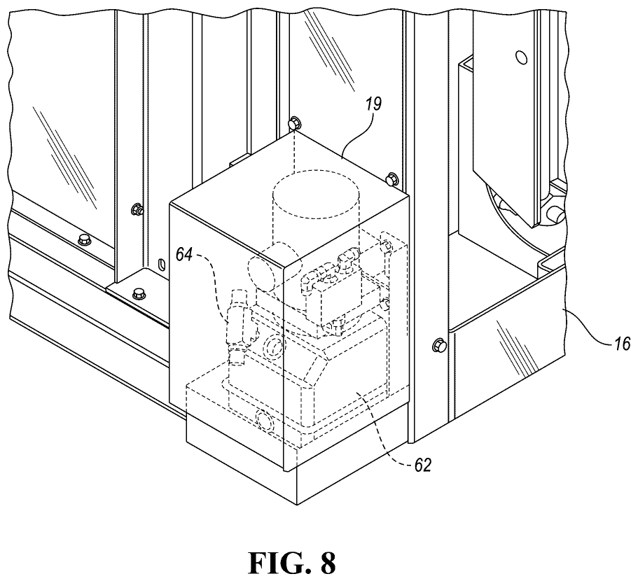

FIG. 8 shows the actuator housing 28 translucent to show a hydraulic pump 62 and a T-fitting 64 that connects to the hydraulic cylinder 44 (FIG. 3) of each lifting mechanism 16 (hydraulic lines not shown). The T-fitting 64 fluidly connects the hydraulic cylinder 44 of each lifting mechanism 16 to each other. The hydraulic pump 62 is controlled by the controller 24. By using a single hydraulic pump 62, the hydraulic cylinders 44 will raise and lower the latches 30 of both lifting mechanisms 16 together.

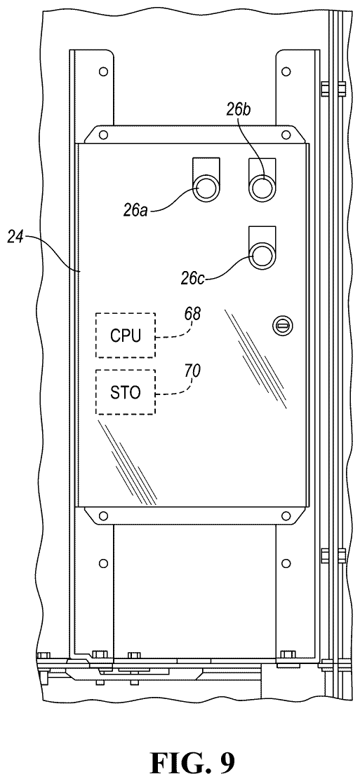

FIG. 9 shows the controller 24. The controller 24 includes at least one processor 68 and storage 70 readable by a computer. The storage 70 stores instructions, which when executed by the at least one processor 68 causes the pallet stacker 10 to perform the functions described herein. The buttons 26 include a raise button 26a, a cancel button 26b and an override button 26c. The at least one processor 68 inside the controller 24 receives all of these user inputs. The use and operation of these buttons will be explained later below.

FIG. 10 is a perspective view of an upper portion of the pallet stacker 10 loaded with pallets 100. A proximity sensor 66 mounted to the upper end of one of the columns 18 will detect when a pallet 100 reaches the top of the corral 12 and send a signal to the controller 24. In response, the controller 24 will prevent any more pallets 100 from being added to the stack, i.e. the controller 24 will not actuate the hydraulic pump 62 to lift the stack of pallets 100 again.

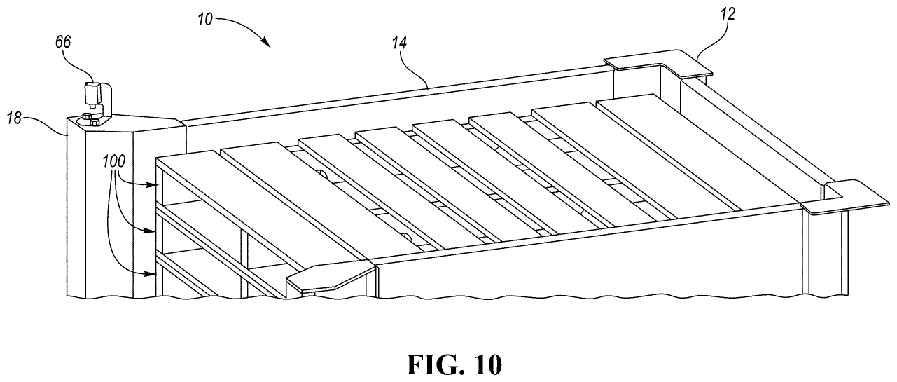

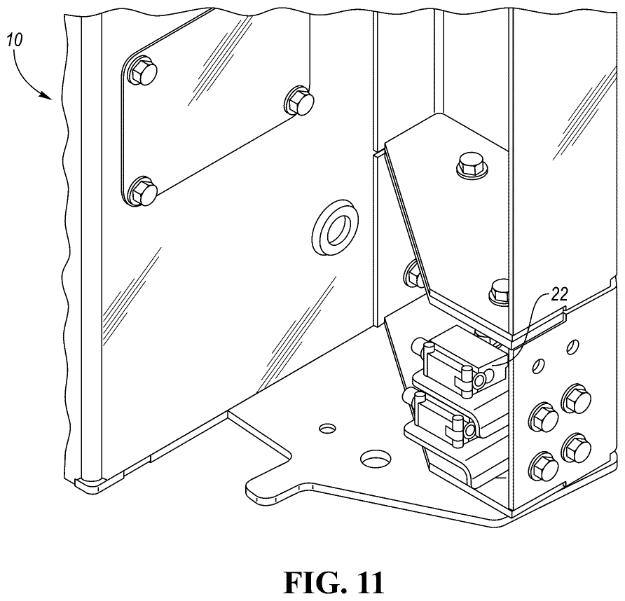

FIG. 11 is an enlarged view of a portion of the photoelectric eye 22.

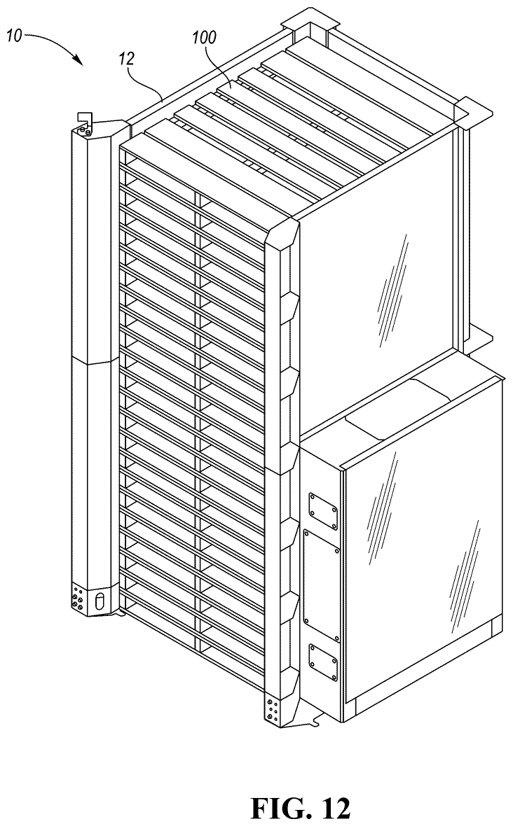

FIG. 12 is a front upper perspective view of the pallet stacker 10 with a plurality of pallets 100 loaded in the corral 12. In FIG. 12, a plurality of wooden pallets 100 are shown, but plastic pallets, such as nestable pallets, rackable pallets, and half pallets could also be used in the pallet stacker 10, with some adjustment or modifications.

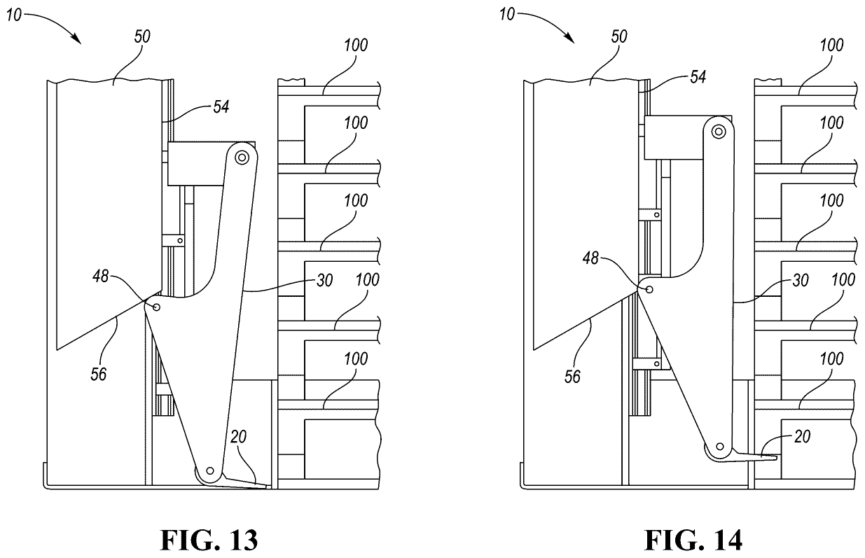

FIGS. 13 to 19 will be referenced to explain the operation of the pallet stacker 10. As explained above, all the latches 30 would be operating the same way at the same times.

FIG. 13 shows the latch 30 in a disengaged position, i.e. when the wheel 48 is not engaging the vertical inner edge 54 of the cam 50. In FIG. 13, the wheel 48 is engaging the outwardly-sloped ramped surface 56. This permits the latch 30 to rotate outward (based upon gravity and the spring 46 (FIG. 7)). This moves the foot 20 to a retracted position away from the pallets 100.

Upon activation of the raise button 26a by a user, (but optionally only if the photoelectric eye 22 detects the presence of at least one pallet 100 and/or pallet jack or other material handling equipment), the controller 24 activates the hydraulic pump 62. This causes the pistons 42 to rise, causing the latches 30 to rise. The latch 30 rises to the position shown in FIG. 14, which is an engaged position. The wheel 48 has traveled up the cam 50, up the outwardly-sloped ramped surface 56 to the vertical inner edge 54. This rotates the latch 30 inward, such that the foot 20 is inserted into an opening in the pallet 100, under a portion of the bottom pallet 100 as shown, typically about four inches from the floor. In this example, the latches 30 and feet 20 are fully deployed when the feet 20 are four inches or more from the floor and the latches 30 and feet 20 are fully retracted when the feet 20 are at the floor. The bottom pallet 100 is on the floor.

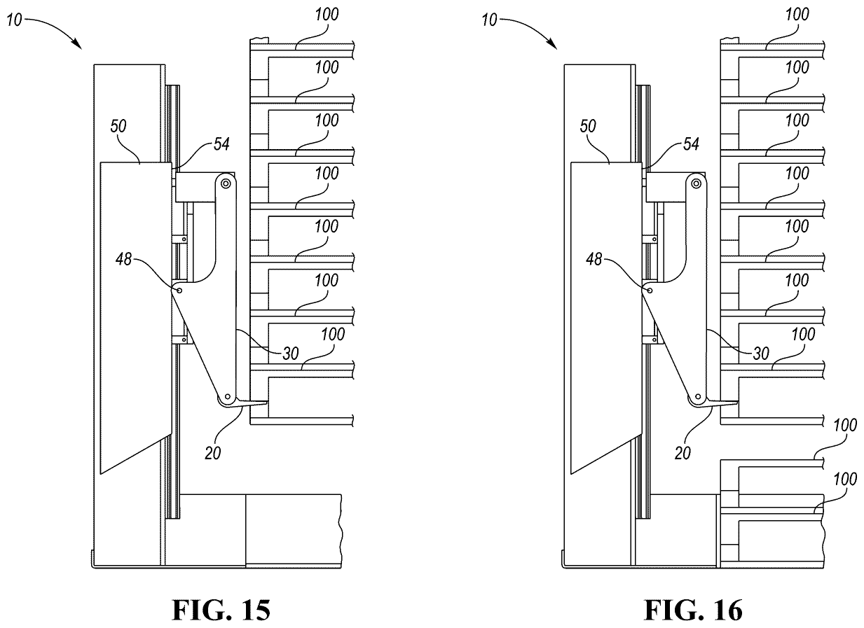

Referring to FIG. 15, as the latch 30 continues to rise, the foot 20 engages the bottom pallet 100 and lifts the stack of pallets 100 upward within the pallet stacker 10. The latches 30 continue to rise as long as the user holds in the raise button 26a. The lift mechanisms are able to lift the latches 30 up to a maximum height, which may be configured such that the bottom surface of the bottom pallet would be a little more than the height of one pallet (but less than two pallets), a little more than two pallets (but less than three pallets), or three pallets 100 (but less than four pallets). Even more could be accommodated with longer pistons 42 and longer hydraulic cylinders 44 (or other actuators).

If at any time, the pallets 100 and/or pallet jack are moved out of the path of the photoelectric eye 22, the operation of the hydraulic pump 62 will cease (as controlled by the controller 24), and the stack of pallets 100 will be lowered. If necessary, the user can also hold in the override button 26c at the same time as the raise button 26a to bypass the photoelectric eye 22. Alternatively, the user can press the cancel button 26b to cause the controller 24 to release the hydraulic pressure and permit the latches 30 to lower the stack of pallets 100 to the floor.

Next, as shown in FIG. 16, the user places at least one, and more preferably two or three new pallets 100 inside the interior storage space of the corral 12 on the floor below the suspended stack of pallets 100. During this time, the latches 30 hold the stack of pallets 100 spaced above the floor within the pallet stacker 10.

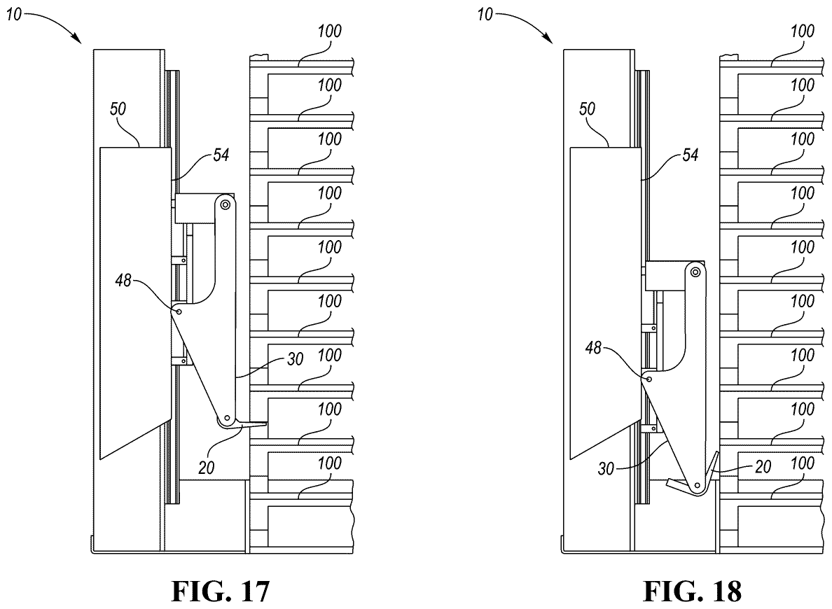

When the added pallets 100 are in place and the pallet jack (or other material handling equipment) is removed, the photoelectric eye 22 is no longer interrupted. This signal is received by the controller 24, which then releases the hydraulic pump 62, which causes the latches 30 to lower slowly. The original stack of pallets 100 is lowered onto the additional pallets 100 as shown in FIG. 17.

As the latches 30 continue to lower, the foot 20 may be flipped upward and outward as shown in FIG. 18 by a lower portion of the pallet 100 (or by the lower pallet(s)). This permits the latches 30 to travel downward past the pallets 100 along the same path that they traveled upward.

As the latch 30 lowers further, the wheel 48 moves onto the outwardly-sloped ramped surface 56 of the cam 50, permitting the latch 30 to rotate outward (via gravity and the spring 46). This pulls the foot 20 outward away from the pallets 100 and out of the interior storage space of the corral 12.

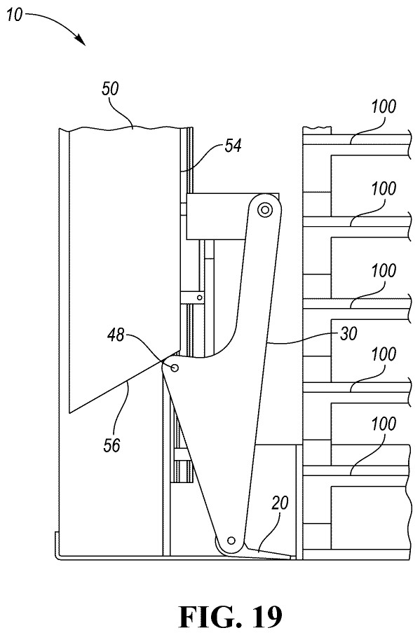

In the rest position shown in FIG. 19, the pallets 100 are supported by the floor, not suspended by any mechanical or hydraulic means. There is no hydraulic pressure. No energy is being consumed (or very little, to operate the photoelectric eye 22).

This process can be repeated until the pallet stacker 10 is full, as indicated by the proximity sensor 66 at the top. Eventually, material handling equipment, such as a forklift, can lift and remove the entire stack of pallets 100 and place them on a truck to be returned to a distribution center for reuse.

The pallet stacker 10 is modular in that the height of the parallel side walls 14 and rear wall 15 could be increased (e.g. with more panels) to create a taller stack of pallets 100.

The hydraulic pump 62 is preferably powered by a 12V battery, which may be connected to AC power by a charger. This makes the pallet stacker 10 safer to work on because there is only 12V power present.

For certain applications, it may be desirable to use food grade oil in the hydraulic pump 62 and hydraulic cylinder 44. For example, in areas involving packaged or non-packaged food on the pallets 100, any leaks or spills of food grade oil would not require significant cleaning or decontamination, as would non-food grade oil.

The hydraulic pump 62, hydraulic cylinder 44 and piston 42 could be replaced with pneumatics or electric motors or other actuators.

In accordance with the provisions of the patent statutes and jurisprudence, exemplary configurations described above are considered to represent preferred embodiments of the inventions. However, it should be noted that the inventions can be practiced otherwise than as specifically illustrated and described without departing from its spirit or scope. Alphanumeric identifiers on method steps are solely for ease in reference in dependent claims and such identifiers by themselves do not signify a required sequence of performance, unless otherwise explicitly specified.

What is claimed is:

1. A pallet stacker comprising:
a corral defining an interior storage space configured to retain a stack of pallets; and
at least one lifting mechanism configured to engage a bottom pallet of the stack of pallets, to lift the stack of pallets to permit insertion of at least one new pallet below the stack of pallets, and to lower the stack of pallets onto the new pallet.

2. The pallet stacker of claim 1 wherein the at least one lifting mechanism includes a latch pivotable and vertically slidable relative to the corral.

3. The pallet stacker of claim 2 wherein the latch engages a cam surface that moves the latch between a deployed position and a retracted position.

4. The pallet stacker of claim 3 wherein the cam surface moves the latch inward from the retracted position to the deployed position between a floor and four inches above the floor.

5. The pallet stacker of claim 2 further including a foot pivotably secured at an lower end of each latch.

6. The pallet stacker of claim 1 wherein the at least one lifting mechanism is configured to engage the bottom pallet on a floor and to lift the stack of pallets more than a height of three stacked pallets, but less than a height of four stacked pallets.

7. The pallet stacker of claim 1 wherein the at least one lifting mechanism includes a first lifting mechanism and a second lifting mechanism positioned on opposite sides of the interior storage space.

8. The pallet stacker of claim 7 wherein each of the first lifting mechanism and the second lifting mechanism includes a piston and hydraulic cylinder connected to a main bracket vertically slidably connected to a slide and at least one latch movable between a deployed position and retracted position.

9. The pallet stacker of claim 8 wherein each of the at least latch engages a cam surface that moves the latch inward from the retracted position to the deployed position.

10. The pallet stacker of claim 9 wherein the cam surface moves the latch inward from the retracted position to the deployed position as the latch moves upward.

11. The pallet stacker of claim 10 wherein the cam surface moves the latch inward from the retracted position to the deployed position between a floor and four inches from the floor.

12. The pallet stacker of claim 8 further including a hydraulic pump fluidly connected to the hydraulic cylinder of the first lifting mechanism and the hydraulic cylinder of the second lifting mechanism.

13. The pallet stacker of claim 1 further including a user interface including a raise switch and wherein the at least one lifting mechanism is configured to lift the stack of pallets as long as the user engages the raise switch.

14. The pallet stacker of claim 1 further including a presence sensor mounted proximate an entry to the storage corral, wherein the at least one lift mechanism is configured to lower the stack of pallets based upon a lack of an indication of presence by the presence sensor.

15. The pallet stacker of claim 1 in combination with a plurality of pallets received in the corral, a bottom pallet of the plurality of pallets engaged by the at least one lifting mechanism.

16. A pallet stacker comprising:
a corral having a pair of opposed, parallel side walls and a rear wall defining an interior storage space configured to retain a stack of pallets;
at least one latch mounted proximate each side wall and pivotable between a retracted position and a deployed position, wherein each latch is slidable vertically relative to the corral; and
a foot pivotably mounted to a lower end of each latch.

17. The pallet stacker of claim 16 wherein each latch is slidable vertically to move the associated foot upward from a position less than four inches above a floor on which the corral rests upward.

18. The pallet stacker of claim 17 wherein each latch engages a cam surface that moves the latch from the retracted position to the deployed position as the foot moves from the floor to four inches above the floor.

19. A method for stacking pallets comprising:
a) lifting a stack of pallets off a floor;
b) after step a), inserting at least one new pallet below the stack of pallets; and
c) after step b), lowering the stack of pallets onto the at least one new pallet.

20. The method of claim 19 further including:
d) detecting a presence of a pallet or pallet-handling apparatus proximate the stack of pallets;
e) after step d), detecting that the pallet or pallet-handling apparatus is no longer present; and
f) performing step c) based upon step e).
